(19) United States
(12) Patent Application Publication
(10) Pub. No.: US 2018/0086193 A1
(43) Pub. Date: Mar. 29, 2018

(54) BATTERY SWAP CONNECTOR AND ELECTRIC VEHICLE COMPRISING THE SAME

(71) Applicant: NIO NEXTEV LIMITED, Hong Kong (CN)

(72) Inventors: Zhanyu FU, Shanghai (CN); Jie FANG, Shanghai (CN); Linfeng WANG, Shanghai (CN); Bo LI, Shanghai (CN)

(21) Appl. No.: 15/716,939

(22) Filed: Sep. 27, 2017

(30) Foreign Application Priority Data
Sep. 27, 2016 (CN) 201610851829.1

(51) Int. Cl. B60K 1/04; H01M 2/10; B60S 5/06; B60L 11/18

(52) U.S. Cl. CPC B60K 1/04; H01M 2/1083; B60R 16/04; B60L 11/1822; B60L 11/1879; B60S 5/06

(57) ABSTRACT

The invention relates to a battery swap connector and an electric vehicle comprising the same. The battery swap connector comprises: a plug at power battery end, on which a plug terminal is disposed; a socket at vehicle body end of electric vehicle, on which a socket terminal is disposed, with which the plug terminal is adapted to be insertedly connected; and an electronic lock device which comprises a mechanical lock-up mechanism which fixes a relative position of the plug and the socket after the inserted connection, and a lock-up state feeding mechanism which feeds a lock-up state of the mechanical lock-up mechanism to an entire vehicle controller of the electric vehicle.

### CROSS-REFERENCE TO RELATED APPLICATIONS

This application claims the benefit of China Patent Application No. 201610851829.1 filed Sep. 27, 2016, the entire contents of which are incorporated herein by reference.

### FIELD OF THE INVENTION

The invention relates to the technical field of quick swap of battery pack for electric vehicle; more specifically, the invention relates to a battery swap connector for the connection between battery pack the vehicle body, and further relates to an electric vehicle comprising the battery swap connector.

### BACKGROUND

As compared to a plug-in new energy electric vehicle, in a battery swap mode, the power battery having insufficient quantity of electricity is directly removed, and a power battery which has finished charging is mounted again. Thereby, a battery swap type electric vehicle does not have the problem of the vehicle owner waiting for a long time to charge the vehicle, and professionals complete the charging of power battery using dedicated devices, which is advantageous for prolonging the service life of power battery.

In swapping battery, with the new power battery mounted in the vehicle, the battery swap connector realizes electrical connection between the power battery and the vehicle. Specifically, a plug of the battery swap connector at the battery pack end is inserted into a socket at the vehicle body end of the electric vehicle, and electrical connection is realized through inserted connection between a plug terminal and a socket terminal.

The power battery quick swap solution for electric vehicle is not widely used in current electric vehicles. In the prior art battery swap connectors, a retention force between the plug and the socket is insufficient, and the vibration of vehicle will cause terminals of the battery swap connector to move towards each other and further lead to problems of arcing, intermittent connection or the like, which may tend to cause damage to control system. Moreover, an assembly state of the prior art battery swap connector will not be fed back to the control system, and a high voltage interlock cannot be realized. Since the assembly state is not definite, there exists the possibility of hot plugging, which is adverse for driving and operation safety.

### SUMMARY OF THE INVENTION

An object of the invention is to provide a battery swap connector that can overcome the above defects in the prior art.

Further, the object of the invention also lies in providing an electric vehicle that comprises such a battery swap connector.

In order to realize the aforesaid objects, a first aspect of the invention provides a battery swap connector, wherein the battery swap connector comprises:
a plug at power battery end, on which a plug terminal is disposed;
a socket at vehicle body end of electric vehicle, on which a socket terminal is disposed, with which the plug terminal is adapted to be insertedly connected; and
an electronic lock device which comprises:
   a mechanical lock-up mechanism which fixes a relative position of the plug and the socket after the inserted connection; and
   a lock-up state feeding mechanism which feeds a lock-up state of the mechanical lock-up mechanism to an entire vehicle controller of the electric vehicle.

Optionally, in the above described battery swap connector, the mechanical lock-up mechanism can fix the relative position in at least one of three directions of X, Y and Z.

Optionally, in the above described battery swap connector, the mechanical lock-up mechanism comprises a stroke rod on the plug, which can be extended and retracted in a controlled way, and a distal end of which comprises a stroke rod head; and
a hole type structure on the socket, which corresponds to the position of the stroke rod and has a non-circular shape consistent with the stroke rod head, wherein
when the stroke rod is extended to the maximum, the stroke rod head is inserted into the hole type structure and can realize the lock-up state after the stroke rod head has rotated by a certain angle.

Optionally, in the above described battery swap connector, the plug is provided with a limit protrusion, and the socket is provided with a limit recess in which a compression spring is placed; in the lock-up state, the limit protrusion projects into the limit recess and presses the compression spring tightly.

Optionally, in the above described battery swap connector, the stroke rod and the hole type structure are close to an intermediate position of the battery swap connector.

Optionally, in the above described battery swap connector, the stroke of the compression spring reaches the maximum in the lock-up state.

Optionally, in the above described battery swap connector, an outer diameter of the limit protrusion is substantially equal to an inner diameter of the limit recess.

Optionally, in the above described battery swap connector, the limit protrusion and the limit recess are located at two sides of the plug terminal and the socket terminal respectively.

Optionally, in the above described battery swap connector, the electronic lock device has an inner control circuit which detects and feeds the lock-up state according to the stroke of the stroke rod and the rotation action of the stroke rod head.

In order to realize the above objects, a second aspect of the invention provides an electric vehicle having the battery swap connector according to any item of the above described first aspect.

### BRIEF DESCRIPTION OF THE DRAWINGS

The disclosure of the invention will become more apparent with reference to the accompanying drawings. It should be understood that these drawings are provided merely for illustrative purpose rather than limiting the scope of protection of the invention, wherein:

FIG. 1 schematically shows a battery swap connector according to an embodiment of the invention, wherein the plug and the socket are in an uninserted state;

FIG. 2 schematically shows the battery swap connector in an inserted state;

FIG. 3 schematically shows an engagement face of the socket of the battery swap connector;

FIG. 4 schematically shows an insertion process of the plug and socket of the battery swap connector;

FIG. 5 schematically shows a lock-up process of the electronic lock device in the battery swap connector;

FIG. 6 schematically shows the force in the battery swap connector.

### DETAILED DESCRIPTION OF THE INVENTION

The specific embodiments of the invention will be described below in detail with reference to the accompanying drawings, in which identical or similar technical features are denoted by identical reference signs.

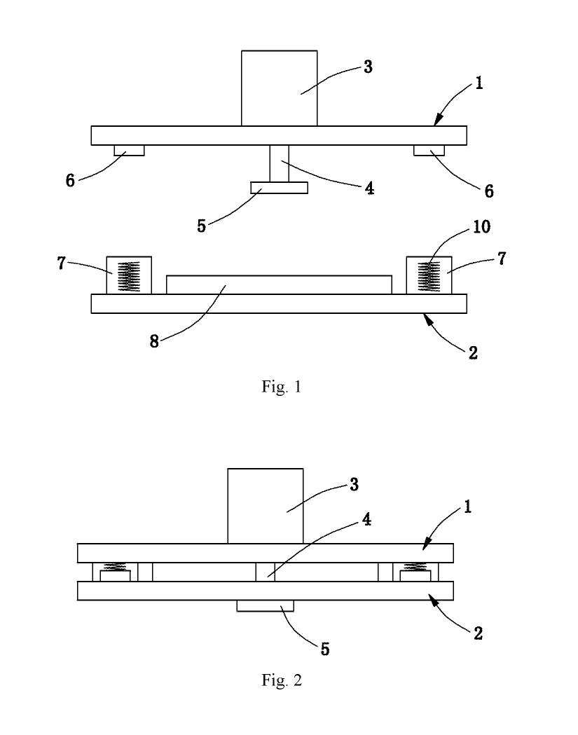

FIG. 1 schematically shows a battery swap connector according to an embodiment of the invention, wherein the plug and the socket are in an uninserted state. FIG. 2 schematically shows the battery swap connector in an inserted state;

As can be seen from these figures, the battery swap connector of the invention comprises a plug 1 and a socket 2, wherein the plug 1 is adapted to be connected to a power battery end (not shown) of the electric vehicle so as to output electrical energy from the power battery, and the socket 2 is adapted to be connected to a vehicle body end (not shown) of the electric vehicle so as to transmit the electrical energy to individual electric components of the vehicle. A plug terminal (not shown) is disposed on the plug 1 at the power battery end, and a socket terminal 8 is disposed on the socket 2 at the vehicle body end of the electric vehicle. The plug terminal and the socket terminal can be male terminal and female terminal respectively, and the plug terminal is adapted to be insertedly connected to the socket terminal 8 so as to realize various electrical connection, e.g., high voltage connection, low voltage connection, etc. It can be understood that in a different specific embodiment, the plug 1, the socket 2, the plug terminal and the socket terminal of the battery swap connector can have different specific shapes and structure, without being limited to the illustrated shape and structure.

In order to enhance the retention force between the plug 1 and the socket 2 after insertion, and to provide a feedback signal indicating whether the locking or unlocking is successful to an entire vehicle controller (not shown), the battery swap connector of the invention further comprises an electronic lock device. Specifically, the electronic lock device can comprise a mechanical lock-up mechanism and a lock-up state feeding mechanism, wherein the mechanical lock-up mechanism is used for fixing a relative position of the plug 1 and the socket 2 after insertion so as to enhance the above retention force; and the lock-up state feeding mechanism is used for feeding a lock-up state of the mechanical lock-up mechanism to the entire vehicle controller of the electric vehicle so as to provide the above signal of whether the locking or unlocking is successful. It can be seen that by providing the above electronic device in the battery swap connector, the invention can effectively solve the problems of insufficient retention force and mutual movement of the terminals, while also providing lock-up state feedback signal, thus increasing driving and operation safety of the quick swap solution.

It can be understood that the mechanical lock-up mechanism should be able to fix the relative position of the plug 1 and the socket 2 in at least one of three directions of X, Y and Z.

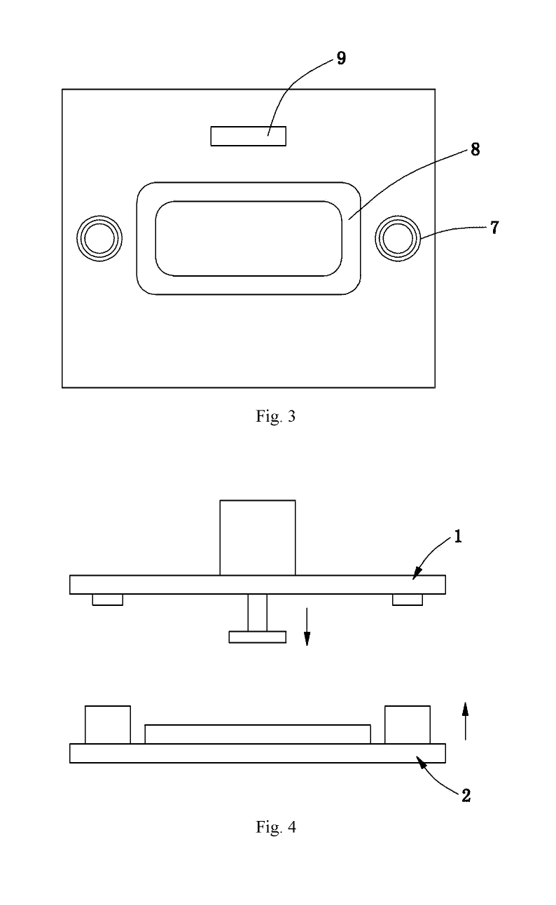

For example, in an optional specific embodiment, the mechanical lock-up mechanism can comprise a stroke rod 4 on the plug 1 which can be extended and retracted in a controlled way, and a hole type structure 9 (see FIG. 3) on the socket 2 which corresponds to the position of the stroke rod 4, wherein a distal end of the stroke rod 4 may comprise a stroke rod head 5, and the hole type structure 9 has a non-circular shape consistent with the stroke rod head 5. FIGS. 1 and 2 further show a controller 3 used for controlling the stroke rod 4 and the stroke rod head 5. When the power battery is in an installation position on the electric vehicle, the plug terminal on the plug 1 will be aligned with the socket terminal on the socket 2, and meanwhile, the stroke rod head 5 will be aligned with the hole type structure 9. As shown in FIG. 2, when the stroke rod 4 is extended to the maximum, the stroke rod head 5 is inserted into the hole type structure 9, and can realize the lock-up state after the stroke rod head 5 has rotated by a certain angle. It can be understood that since both the hole type structure 9 and the stroke rod head 5 have consistent non-circular shapes, the stroke rod head 5 can be inserted into the hole type structure, and after the stroke rod head 5 is rotated, at a certain position, it will be placed into a state where it can not be withdrawn from the hole type structure 9. That is, locking is realized in a direction (Z direction) in which the plug 1 and the socket 2 are prevented from departing from each other.

In a preferred specific embodiment, the plug 1 can be further provided with a limit protrusion 6, and the socket 2 can be provided with a limit recess 7. When the power battery is located at the installation position on the electric vehicle, the limit protrusion 6 and the limit recess 7 are aligned. In the lock-up state, the limit protrusion 6 projects into the limit recess 7, and the limit protrusion 6 and the limit recess 7 can abut in a certain side direction so as to realize locking in the corresponding direction (X or Y direction) and to provide a retention force in the corresponding direction. In the illustrated embodiment, an outer diameter of the limit protrusion 6 can be substantially equal to an inner diameter of the limit recess 7. At this point, a movement of the plug 1 and the socket 2 in engaged face is restricted (locked and retention force provided in the X and Y directions).

In the illustrated embodiment, a compression spring 10 is further preferably disposed in the limit recess 7. In the lock-up state, the limit protrusion 6 can press the compression spring 10 tightly, and since the stroke rod head 5 simultaneously engages with the hole type structure 9, the plug and the socket can be prevented from loosening in the extending and retracting direction of the spring. More preferably, the stroke of the compression spring 10 can reach the maximum in the lock-up state. With this mechanical lock-up mechanism design comprising the compression spring, a firm fixation of the relative position after the battery swap connector is inserted can be further enhanced, thus further increasing the retention force of the connector and avoiding the problems of arcing and intermittent connection or the like caused by a mutual movement of the terminals in the insertion direction.

FIG. 3 schematically shows an engagement face of the socket of the battery swap connector.

As can be seen from the figure, the limit recess 7 can be located at two sides of the socket terminal 8; accordingly, although not shown, it can be understood that the limit protrusion 6 will be located at two sides of the plug terminal that is not shown. For example, it can be seen from FIGS. 1 and 2 that the positions of the limit protrusion 6 correspond to those of the limit recess 7 so as to facilitating mating with each other.

It can be understood that according to the teaching of the application, those skilled in the art can envisage using limit protrusions and limit recesses in another numbers and in another arrangement, and can even envisage using limit protrusions and limit recesses having other cross sectional shapes, without being limited to the circular section as shown. Those skilled in the art will appreciate that the plug terminal is adapted to have the same arrangement as the socket terminal 8, but is not limited to the rectangular arrangement shown in FIG. 3.

Meanwhile, it can be also seen from FIG. 3 that the hole type structure 9 on the socket 2 is disposed close to an intermediate position of the socket; accordingly, it can be envisaged that in this embodiment, the stroke rod 4 will also have to be disposed close to an intermediate position of the plug so that the position of the stroke rod 4 corresponds to the position of the hole type structure 9. It can be understood that according to the teaching of the application, those skilled in the art can also envisage disposing the hole type structure 9 and the stroke rod 4 at other positions of the battery swap connector, without being limited to the intermediate position; according to a specific application, the number of the hole type structure 9 and the stroke rod 4 (comprising the stroke rod head 5) can be also adjusted.

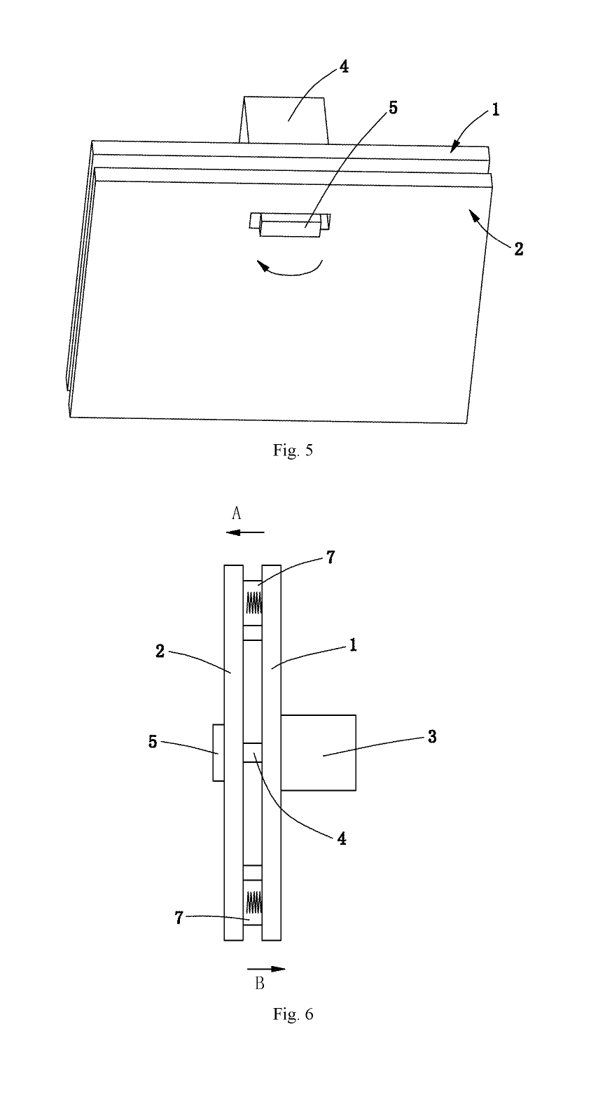

FIG. 4 schematically shows an insertion process of the plug and socket of the battery swap connector, and the arrows show the movement directions of the plug and the socket respectively. FIG. 5 schematically shows a lock-up process of the electronic lock device in the battery swap connector, and the arrow show a rotation direction of the stroke rod head. As can be seen from FIG. 5 that in this embodiment, the stroke rod head 5 and the hole type structure 9 employ a rectangular structure by way of example. Those skilled in the art can envisage other non-circular structures. It can be understood that according to different non-circular structures, the specific angles by which the stroke rod head 5 has to rotate for realize locking may be different.

According to the invention, the electronic lock device can have an inner control circuit which detects and feeds the lock-up state according to the stroke of the stroke rod and a rotation action of the stroke rod head. Specifically, in the invention, the lock-up state can be fed back to the entire vehicle controller by making use of the different mechanical strokes of the stroke rod of the electronic lock device, and meanwhile, the lock-up state signal is provided to the entire vehicle controller so as to ensure proper connection. The extending and retracting of the stroke rod of the electronic lock device and the rotation of the stroke rod head can be realized by an electromagnetic structure. For example, when the entire vehicle controller inputs +12V, the stroke rod is extended or the stroke rod head is rotated clockwise, and when entire vehicle controller inputs −12V, the stroke rod is retracted or the stroke rod head is rotated counterclockwise. The sequence of controlling the stroke rod and the stroke rod head of the electronic lock is controlled by the entire vehicle controller software. For example, during assembling, the stroke rod is firstly controlled to extend, and then the stroke rod head is controlled to rotate clockwise, thus realizing locking function; and during disassembling, the stroke rod head is firstly controlled to rotate counterclockwise, and then the stroke rod is controlled to retract, thus realizing unlocking function. It can be understood that in the invention, it is required to precisely design the stroke of the stroke rod of the electronic lock device so that the stroke of the stroke rod just reaches a distance that passes through the installation face of the plug, and a successful lock-up signal is fed back only when the stroke of the stroke rod and the rotation of the stroke rod head are simultaneously detected. This is also true for the disassembling process.

The assembling process of the battery swap connector in the illustrated embodiment will be described below with more details.
(1) as shown in FIG. 4, the plug at the power battery end is inserted into the socket at the vehicle body end, and the limit protrusion on the plug continuously compresses the spring on the socket; at this point, the stroke rod of the electronic lock device extends out when driven by the entire vehicle controller;
(2) as shown in FIG. 5, at this point, the stroke of the stroke rod has extended to the maximum, and the stroke rod head passes through the rectangular hole type structure at the plug end, whereas the stroke of the spring compression also reaches the maximum; then, the stroke rod head is rotated clockwise so as to exert locking action;
(3) as shown in FIG. 6, at this point, the plug of the battery swap connector cannot move relative to the socket in the A direction due to the elastic force of the spring, and cannot move relative to the socket in the B direction due to the locking action of the stroke rod head; similarly, the socket of the battery swap connector cannot move relative to the plug in the B direction due to the elastic force of the spring, and cannot move relative to the plug in the A direction due to the locking action of the stroke rod head, thus solving the problems of intermittent connection or arcing caused by movement of the terminals inside the battery swap connector in the A or B direction.

It can be understood from the above description with reference to the individual drawings that in the invention, an electronic lock device is added on the battery swap connector, which provides a mechanical mechanism locking function during the assembling process of the power battery swapping solution, wherein the relative position after the plug and the socket are insertedly connected is firmly fixed so that the retention force during insertion is increased, thus avoiding the problems of arcing and intermittent connection or the like caused by a mutual movement of the connector terminals in the vibration of the vehicle; moreover, a feedback signal indicating whether the locking or unlocking is successful is provided to the entire vehicle controller, which is equivalent to a high voltage interlock signal; before the quick swap connector is pulled out, an electrical signal of the entire vehicle controller is required for unlocking, thus avoiding hot plugging and ensuring the safety of the quick swap solution.

It can be understood from the above description with reference to the individual drawings that those skilled in the art can envisage applying the above described battery swap connector to electric vehicles so that one of the plug and socket is connected to the power battery of the electric vehicle, and the other is connected to the electric motor itself. It can be understood that the electric vehicle obtained in this way will also have the advantages corresponding to the battery swap connector of the invention.

The technical solution of the invention is not merely limited to the above contents of the description, and under the premise of not departing from the technical ideas of the invention, those skilled in the art can made various variations and modifications on the above embodiments, which should all fall within the scope of the invention.

1. A battery swap connector, characterized in that the battery swap connector comprises:
a plug at power battery end, on which a plug terminal is disposed;
a socket at vehicle body end of electric vehicle, on which a socket terminal is disposed, with which the plug terminal is adapted to be insertedly connected; and
an electronic lock device which comprises:
a mechanical lock-up mechanism which fixes a relative position of the plug and the socket after the inserted connection; and
a lock-up state feeding mechanism which feeds a lock-up state of the mechanical lock-up mechanism to an entire vehicle controller of the electric vehicle.

2. The battery swap connector according to claim 1, wherein the mechanical lock-up mechanism can fix the relative position in at least one of three directions of X, Y and Z.

3. The battery swap connector according to claim 1, wherein the mechanical lock-up mechanism comprises a stroke rod on the plug, which can be extended and retracted in a controlled way, and a distal end of which comprises a stroke rod head; and
a hole type structure on the socket, which corresponds to the position of the stroke rod and has a non-circular shape consistent with the stroke rod head, wherein
when the stroke rod is extended to the maximum, the stroke rod head is inserted into the hole type structure and can realize the lock-up state after the stroke rod head has rotated by a certain angle.

4. The battery swap connector according to claim 3, wherein the plug is provided with a limit protrusion, and the socket is provided with a limit recess in which a compression spring is placed; in the lock-up state, the limit protrusion projects into the limit recess and presses the compression spring tightly.

5. The battery swap connector according to claim 4, wherein the stroke rod and the hole type structure are close to an intermediate position of the battery swap connector.

6. The battery swap connector according to claim 4, wherein the stroke of the compression spring reaches the maximum in the lock-up state.

7. The battery swap connector according to claim 4, wherein an outer diameter of the limit protrusion is substantially equal to an inner diameter of the limit recess.

8. The battery swap connector according to claim 4, wherein the limit protrusion and the limit recess are located at two sides of the plug terminal and the socket terminal respectively.

9. The battery swap connector according to claim 1, wherein the electronic lock device has an inner control circuit which detects and feeds the lock-up state according to the stroke of the stroke rod and the rotation action of the stroke rod head.

10. An electric vehicle having the battery swap connector according to claim 1.
